(19) United States
(12) Patent Application Publication
(10) Pub. No.: US 2017/0153381 A1
(43) Pub. Date: Jun. 1, 2017

(54) BACKLIGHT DEVICE

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Zhishuai JIA, Beijing (CN)

(21) Appl. No.: 15/240,107

(22) Filed: Aug. 18, 2016

Related U.S. Application Data
(63) Continuation of application No. PCT/CN2016/083050, filed on May 23, 2016.

(30) Foreign Application Priority Data
Nov. 27, 2015 (CN) 2015209709225

(51) Int. Cl. F21V 8/00

(52) U.S. Cl. CPC G02B 6/0068; G02B 6/0016; G02B 6/0023; G02B 6/0073

(57) ABSTRACT

Disclosed is a backlight device comprising a light-emitting diode (LED) lamp and a light-guiding plate (3), the light-guiding plate being disposed next to the LED lamp to receive light emitted by the LED lamp, the LED lamp including a white LED lamp (1) and a ultraviolet LED lamp (2) which are arranged adjacent to each other, a phosphor layer (32) being provided on the light-guiding plate (3), and the phosphor layer (32) being located on a portion of the light guide plate (3) which corresponds to the UV LED lamp (2).

### CROSS REFERENCE TO RELATED APPLICATIONS

This application claims the priority to Chinese patent Application No. 201520970922.5, titled “BACKLIGHT DEVICE FOR IMPROVING 3D EFFECT”, filed with the State Intellectual Property Office of PRC on Nov. 27, 2015, which is incorporated herein by reference in its entirety.

### TECHNICAL FIELD

The disclosure relates to a backlight device, and particularly to a backlight device in which light propagation is in a rectangular form.

### BACKGROUND

Currently, the 3D technology includes a FPR technology (i.e., Film Patterned Retarder 3D technology) and a SG technology (i.e., Shutter Glass 3D technology), and the FPR is very expensive. The SG technology includes a blinking backlight technology and a scanning backlight technology both. The scanning backlight technology has a better effect, but there are still problems of crosstalk and ghosting in the scanning backlight technology.

As shown in FIG. 1, to ensure the 3D effect, theoretically the light emitted by a LED (i.e. light-emitting diode) in a region 1 propagate completely in region 1 of a LGP (i.e. light-guiding plate), but does not reach a region 2 which is adjacent to the region 1. Similarly, it is needed to make the light emitted by each region propagate in its respective region and not diverged to the adjacent region. However, as shown in FIG. 2, the light emitted by the LED is actually a fan shape which will lead to the crosstalk, and is unlikely to be a rectangle as shown in FIG. 1. As shown in FIG. 3, currently, a fan angle of the LED is reduced as small as possible by means of a prism structure on the light-guiding plate, but it still could not reach the requirements for the rectangle.

### SUMMARY

An object of embodiments of the disclosure is to provide a backlight device.

To achieve the above object, specific technical solutions of the backlight device according to the embodiments of the disclosure are:

A backlight device for improving 3D effect includes a light-emitting diode (LED) lamp and a light-guiding plate, the light-guiding plate being disposed next to the LED lamp to receive the light emitted by the LED lamp, the LED lamp including a white LED lamp and a ultraviolet LED lamp which are arranged adjacent to each other, and a phosphor layer being provided on the light-guiding plate, the phosphor layer being located on a portion of the light-guiding plate which corresponds to the ultraviolet LED lamp.

Further, a prism structure is provided on the light-guiding plate, and the prism structure is located on a portion of the light-guiding plate which corresponds to the corresponding white LED lamp.

Further, the prism structure includes a plurality of triangular prisms.

Further, the phosphor layer has a phosphor which can generate white light.

Further, there are provided a plurality of the white LED lamps.

Further, there are provided a plurality of the ultraviolet LED lamps.

Further, the white LED lamps and the ultraviolet LED lamps are arranged to be spaced from each other.

Further, a plurality of prism structures corresponding to the white LED lamp are arranged on the light-guiding plate.

Further, a plurality of phosphor layers corresponding to the ultraviolet LED lamp are arranged on the light-guiding plate.

The embodiments of the disclosure have advantages as follows:

1) Because the prism structure, which can make light transversely converged, is provided on the light-guiding plate which is corresponding to the white LED lamp, and thus the generated white light does not be excited to the phosphor on the other regions of the light-guiding plate;

2) Even if the invisible ultraviolet diverges to other regions of the light-guiding plate, the screen will not be affected;

3) Because the light emitted by each region of the LED is linear in respective regions of the light-guiding plate, and the light propagation may present a rectangular form rather than a fan form, the crosstalk is reduced and the quality of 3D screen is improved.

### BRIEF DESCRIPTION OF THE DRAWINGS

FIG. 1 is a schematic view of a distribution of an existing light-guiding plate with the scanning backlight;

FIG. 2 is a diagram of an actual effect of FIG. 1;

FIG. 3 is a sectional view of FIG. 1 taken along A-A;

FIG. 4 is a schematic view of a distribution of the light-guiding plate of the disclosure; and

FIG. 5 is a sectional view of FIG. 4 taken along B-B.

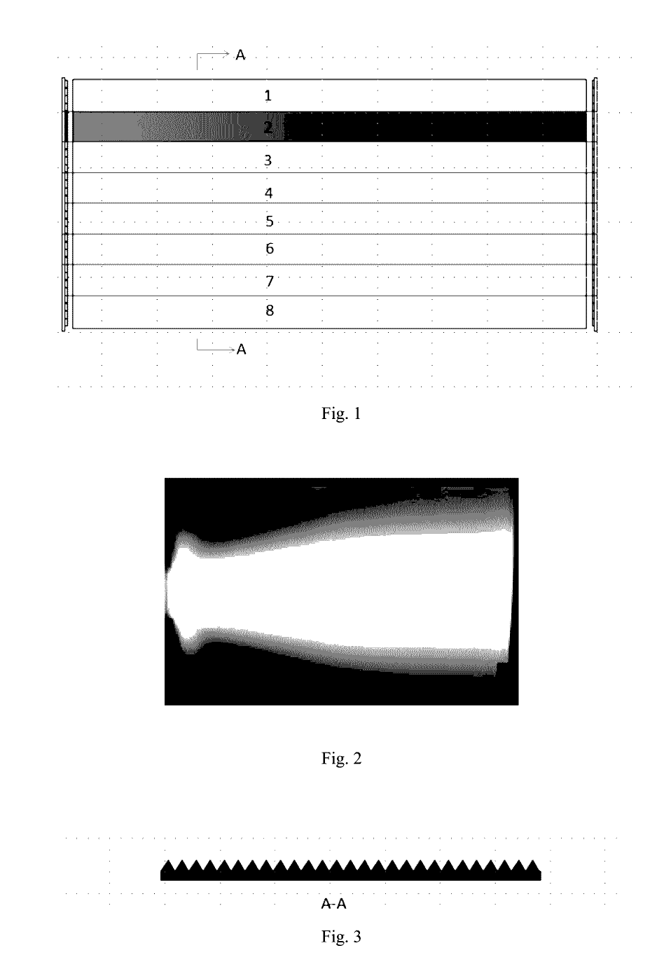

### DETAILED DESCRIPTION

In order to better understand the purpose, structure and function of the disclosure, embodiments of the disclosure will be described below in further detail in conjunction with the accompanying drawings.

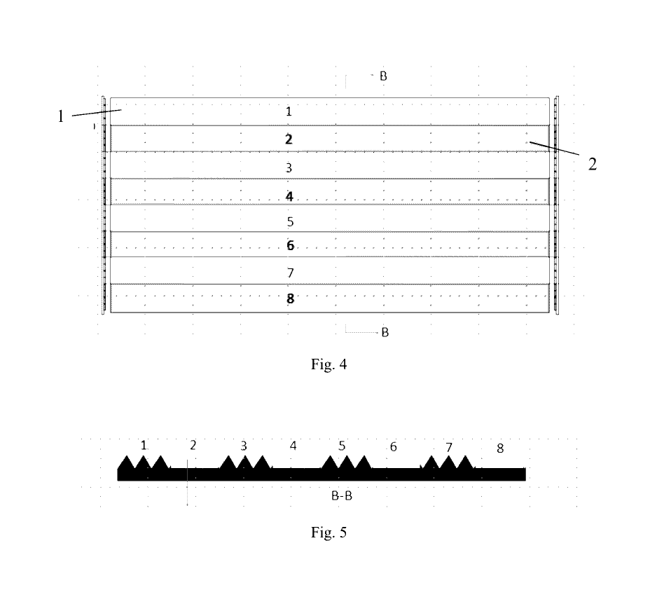

As shown in FIG. 4 and FIG. 5, there is shown a backlight device for increasing 3D effect according to the disclosure, which includes a LED lamp and a light-guiding plate 3 (i.e. LGP) which is arranged next to the LED lamp. The light-guiding plate may receive the light emitted by the LED lamp. The LED lamp includes a white LED lamp 1 which may emit white light and an ultraviolet LED lamp 2 which may emit ultraviolet. The white LED lamp 1 and the ultraviolet LED lamp 2 are arranged adjacent to each other. The light-guiding plate 3 is provided with a prism structure 31 and a phosphor layer 32, which are respectively located on a portion corresponding to the white LED lamp 1 and a portion corresponding to the ultraviolet LED lamp 2 on the light-guiding plate 3. The light emitted by the white LED lamp 1 and by the ultraviolet LED lamp 2 propagates linearly after passing through the prism structure 31 and the phosphor layer 32 on the light-guiding plate, and the light propagation is a rectangular form within the backlight device, thereby avoiding the light generated by the adjacent LED lamps to interfere with each other and form a fan form, and improving the quality of 3D screen.

Further, the phosphor layer 32 on the light-guiding plate 3 corresponding to the ultraviolet LED lamp 2 is provide with a phosphor, which can generate white light. Since ultraviolet of the ultraviolet LED lamp 2 is not visible, even if the ultraviolet generated by the ultraviolet LED lamp 2 diverges to an adjacent white LED lamp 1, it will not be perceived by human eyes. It may be considered that the light emitted by the ultraviolet LED lamp only partially propagates in the phosphor layer 32 on the light-guiding plate, and the light propagation still presents a rectangular form.

Further, the prism structure 31 on the light-guiding plate 3 corresponding to the white LED lamp 1 includes a plurality of triangular prisms which may make lights transversely converged so as to reduce the fan angle. When the white light generated by the white LED lamp 1 diverges to the adjacent phosphor layers 32, the phosphor on the light-guiding plate 3 is not excited by the white light, so the ultraviolet LED lamp which has received the white light will not generate light, and thus it may be considered that the light of the white LED lamp 1 will only partially propagate in the prism structure on the light-guiding plate, so the light of the backlight device may propagate in a rectangular form.

Further, in the disclosure, there are provided with a plurality of the white LED lamps 1 and a plurality of the ultraviolet LED lamps 2. The white LED lamps 1 and the ultraviolet LED lamps 2 are arranged to be spaced from each other. The light-guiding plate 3 is provided with a plurality of prism structures 31 and the phosphor layers 32 corresponding to the white LED lamps 1 and the ultraviolet LED lamps 2, wherein the number of the prism structures 31 provided on the light-guiding plate 3 is the same as the number of the white LED lamps 1, and the number of the phosphor layer 32 provided on the light-guiding plate 3 is the same as the number of the ultraviolet LED lamps 2.

For example, in the disclosure, there are provided four layers of the white LED lamps 1 and four layers of the ultraviolet LED lamps 2, which are arranged to be spaced apart within eight regions of the light-guiding plate 3. Among the eight regions, region 1, region 3, region 5 and region 7 are prism structures, which are corresponding to the white LED lamp 1 and configured to receive the light emitted by the white LED lamp 1. Region 2, region 4, region 6 and region 8 are phosphor layers, which are corresponding to the ultraviolet LED lamp 2 and configured to receive the ultraviolet emitted by the ultraviolet LED lamp 2.

Since the ultraviolet emitted by the ultraviolet LED lamp 2 is not visible, even if the ultraviolet which should diverge to the region 2, the region 4, the region 6 and the region 8 diverges to the adjacent the region 1, the region 3, the region 5 and the region 7, it will not be perceived.

The white light generated by the white LED lamp 1 diverges to the region 1, the region 3, the region 5, and the region 7 of the light-guiding plate, and some of the white light would diverge to the adjacent the region 2, the region 4, the region 6 and the region 8. Because the region 2, the region 4, the region 6 and the region 8 on the light-guiding plate 3 are provided with the phosphor layer 32 which cannot be excited by white light, the region 2, the region 4, the region 6 and the region 8 will not generate light. Thus, the light within the eight regions propagates linearly, and the propagation of the light within the backlight device presents a rectangular form.

With the backlight device for improving 3D effect according to the disclosure, the light-guiding plate corresponding to the white LED lamp is provided with a prism structure, which may make light transversely converged, therefore the generated white light do not to be excited to the phosphor on a different region of the light-guiding plate; even if the invisible ultraviolet diverges to other regions on the light-guiding plate, it cannot affect the screen; the light emitted by the LED on each region propagates linearly on the respective regions of the light-guiding plate, which may present as a rectangular form instead of a fan shape, thereby reducing the crosstalk and thereby improving the quality of 3D screens.

While the disclosure has been further described by means of specific embodiments above, it should be understood that the detailed description herein should not be construed as limiting the spirit and scope of the disclosure, and various modifications made to the embodiments by one of ordinary skill in the art upon reading this specification are within the scope of protection of the disclosure.

1. A backlight device comprising a light-emitting diode, LED, lamp and a light-guiding plate, the light-guiding plate being disposed next to the LED lamp to receive light emitted by the LED lamp, wherein the LED lamp includes a white LED lamp and a ultraviolet LED lamp which are arranged adjacent to each other, and a phosphor layer is provided on the light-guiding plate, the phosphor layer being located on a portion of the light-guiding plate which corresponds to the ultraviolet LED lamp.

2. The backlight device according to claim 1, wherein a prism structure is provided on the guide plate, the prism structure being located on a portion of the light-guiding plate which corresponds to the corresponding white LED lamp.

3. The backlight device according to claim 2, wherein the prism structure comprises a plurality of triangular prisms.

4. The backlight device according to claim 1, wherein the phosphor layer has a phosphor which can generate white light.

5. The backlight device according to claim 1, wherein a plurality of white LED lamps are arranged.

6. The backlight device according to claim 1, wherein a plurality of ultraviolet LED lamps are arranged.

7. The backlight device according to claim 1, wherein the ultraviolet LED lamps and the white LED lamps are arranged to be spaced from each other.

8. The backlight device according to claim 2, wherein a plurality of prism structures corresponding to the white LED lamps are arranged on the light-guiding plate.

9. The backlight device according to claim 1, wherein a plurality of phosphor layers corresponding to the ultraviolet LED lamps are arranged on the light-guiding plate.
